(19) United States
(12) Patent Application Publication
(10) Pub. No.: US 2011/0184945 A1
(43) Pub. Date: Jul. 28, 2011

(54) LOCATION AWARE RECOMMENDATION ENGINE

(75) Inventors: Saumitra Mohan Das, San Jose, CA (US); Rajarshi Gupta, Santa Clara, CA (US); Behrooz Khorashadi, San Jose, CA (US)

(73) Assignee: QUALCOMM Incorporated, San Diego, CA (US)

(21) Appl. No.: 12/846,687

(22) Filed: Jul. 29, 2010

Related U.S. Application Data
(60) Provisional application No. 61/297,666, filed on Jan. 22, 2010.

(51) Int. Cl. G06F 17/30

(52) U.S. Cl. 707/724; 707/E17.014

(57) ABSTRACT

The subject matter disclosed herein relates to a location aware recommendation engine. In response to a recommendation request, relevant recommendations may be ranked based on the current location of a user, location associated with an entity, and/or accessibility criteria.

### CLAIM OF PRIORITY UNDER 35 U.S.C. §119

This application claims priority to provisional patent application Ser. No. 61/297,666, entitled “Location-aware Ordering of Search Results,” filed on Jan. 22, 2010, assigned to the assignee hereof, and expressly incorporated by reference herein.

### BACKGROUND

1. Field

The subject matter disclosed herein relates generally to a location aware recommendation engine.

2. Information

Different methods may be utilized for determining the location of a mobile station (MS), such as a cell phone, tablet, personal digital assistant (PDA), e-book reader, smartbook, netbook, or any other MS. For example, some MS's may utilize a Satellite Positioning System (SPS) such as the Global Positioning System (GPS), or a combination of an SPS and cellular base stations, to determine their locations.

Many mobile stations have the ability to conduct searches for places, e.g., via a Web based search engine or mapping application. Search results returned by a search engine may be displayed in the order of relevancy. For example, a search string of “fast food” may return general information on fast food restaurants, such as KFC's official web address and maybe some fast food restaurants in the user's general metropolitan area. This information may not be immediately helpful to a pedestrian who is inside a mall or an amusement park looking for food at lunch time. Mapping applications may mark the current location of the user on a map and provide, for example, the fast food restaurants within two miles of the user, where the distance between a particular fast food restaurant and the user is determined using a straight line distance between the restaurant's location and the user's location. Again, such results may not be helpful to a pedestrian, for example, who is inside an airport and looking to get food in ten minutes in order to catch a flight.

### BRIEF DESCRIPTION OF THE FIGURES

Non-limiting and non-exhaustive features will be discussed with reference to the following figures, wherein like reference numerals refer to like parts throughout the various figures.

FIG. 1A illustrates the first (ground) level of an indoor shopping venue and a user carrying a mobile station traveling inside the venue.

FIG. 1B illustrates the second level of the indoor shopping venue of FIG. 1A.

FIG. 2 illustrates a database listing entities in and near the shopping venue and information about the entities.

FIG. 3 illustrates a mobile station displaying location aware ordering of recommendations for the indoor shopping venue.

FIG. 4 illustrates a methodology for generating the location aware ordering of recommendations of FIG. 3.

FIG. 5 illustrates a mobile station displaying another example of location aware ordering of recommendations.

FIG. 6 illustrates a mobile station displaying yet another example of location aware ordering of recommendations.

FIG. 7 is an illustrative diagram for generating location aware ordering of recommendations.

FIG. 8 illustrates a block diagram of a system for communicating with a mobile station.

### SUMMARY

In one particular design, a method is provided for ranking recommendations for a pedestrian environment. A search request may be received. In response to the search request: one or more search results associated with the pedestrian environment may be determined; a location of a mobile station associated with the search request may be determined; at least a portion of the one or more search results may be ranked based at least in part on the location of the mobile station and at least one of: location associated with the at least a portion of the one or more search results, and/or accessibility criteria. It should be understood, however, that this is merely an example design and that claimed subject matter is not limited in this respect.

### DETAILED DESCRIPTION

Reference throughout this specification to “one example”, “one feature”, “an example” or “a feature” means that the description in connection with the feature and/or example may be included in at least one feature and/or example of claimed subject matter. Thus, the appearances of such phrases in various places throughout this specification are not necessarily all referring to the same feature and/or example. Particular descriptions of features, examples, and/or functionalities may be combined in one or more features, examples, and/or functionalities. In this specification, the terms “location” and “position” may be used interchangeably. In this specification, the terms “search request” and “recommendation request” may be used interchangeably, and the terms “search result” and “recommendation result” may be used interchangeably.

A pedestrian environment may refer to a pedestrian-accessible environment or area. For example, an area where a pedestrian may walk, run, ride in a wheelchair, bike, or otherwise physically move from one location to another may comprise a pedestrian environment. Examples of pedestrian environments may include indoor environments and outdoor environments. Examples of indoor pedestrian environments include enclosed structures such as office buildings, hotels, shopping malls, warehouses, grocery stores, casinos, museums, transportation terminals (e.g., airports, subway stations, ferry/cruise terminals, etc.), convention centers, and sports stadiums, to name just a few among many possible examples. Examples of outdoor pedestrian environments include beaches, boardwalks, amusement parks, zoos, outdoor shopping malls/strips, outdoor markets, parks, and areas having pedestrian-accessible paths, such as sidewalks, to name just a few among many possible examples.

Navigation for a pedestrian, such as in an indoor environment, may require a different approach than navigation for a driver of a car. For example, signals such as GPS signals or cellular signals may be degraded and unreliable in an indoor structure (e.g., shopping mall, airport, office building, etc.) or an outdoor urban canyon such as midtown Manhattan, where clear views to transmitters of such signals may be blocked. In addition, pedestrian venues often present obstacles such as stairs, elevators, and escalators and barriers such as restricted access areas that may add complexity to navigation. Stairs, elevators, and escalators not only present a physical obstacle in a pedestrian's path but also represent a floor change which may take the pedestrian out of his/her current floor/location context and place him/her in a new, and possibly unfamiliar floor/location context. Given the limited travel range of a pedestrian compared to a vehicle, the amount of points of interests (POIs) such as restaurants, stores, theaters, rest rooms, or other entities accessible to the pedestrian at any one time may be limited to an area within convenient walking distance. Thus, when a pedestrian enters a search request in a search application on his/her mobile station, it may be helpful to limit POIs in the search results to those that are within convenient walking distance (or travel distance if pedestrian is in a wheelchair) and rank the search results in the order of ease of accessibility, for example.

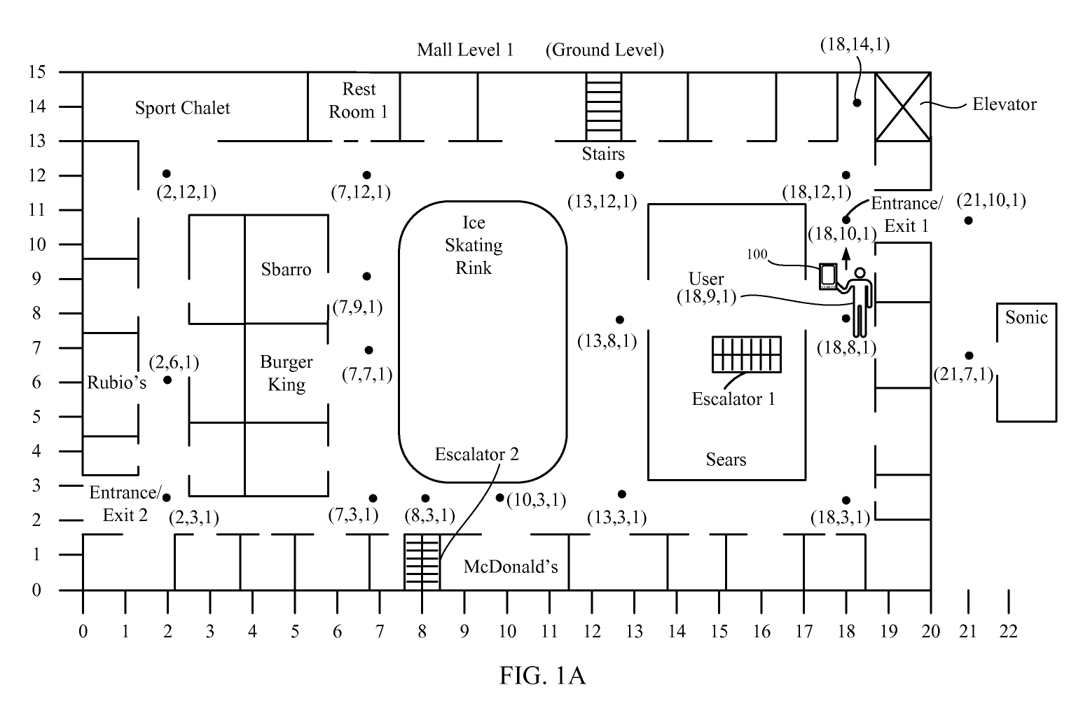

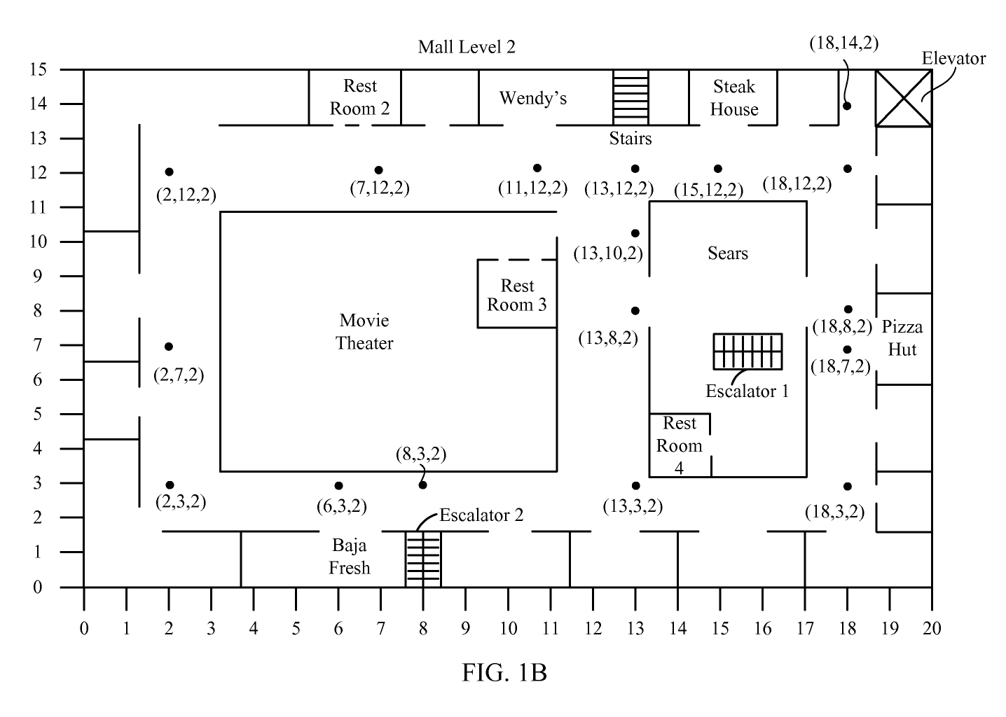

FIG. 1A illustrates the first level of an indoor shopping mall and a pedestrian user carrying mobile station 100 traveling inside the mall. FIG. 1B illustrates the second level of the shopping mall. Navigation signals from an SPS such as GPS may not be available inside the mall. There may be ways in which a location of mobile station 100 may be determined within an area in which SPS signals are unavailable. There may be devices located within the area that have known, fixed locations. For example, wireless devices with fixed and known locations may be dispersed throughout the mall of FIGS. 1A and 1B. Such wireless devices may transmit signals and a mobile station's location may be determined by trilateration based on such signals. In an area where SPS signals are unavailable, for example, a mobile station may estimate its location by utilizing signals involving nearby wireless devices. Such signals may comprise, for example, Institute of Electrical and Electronics Engineers (IEEE) 802.11-compliant (Wi-Fi) signals, signals involving femtocells, Bluetooth signals, etc.

Pedestrian venue operators may be increasingly deploying wireless devices such as Wi-Fi access points or femtocells to provide connectivity to voice or data networks as an extension or substitute for cellular tower signals, which may be degraded or unreliable in an indoor pedestrian environment. For example, Wi-Fi access points (not shown in FIGS. 1A and 1B) may be deployed throughout the shopping mall. The position of a user's mobile station (and thus of the user) may be determined by trilateration utilizing Wi-Fi signals, for example. Mobile station 100 may determine its location, e.g., by performing calculations itself or sending a location determination request to a server and receiving a calculated location from the server. As the user enters the mall, mobile station 100 may start communicating with Wi-Fi access points inside the mall and a position determination utilizing Wi-Fi signals may indicate that MS 100 is inside the mall. Upon determining that MS 100 is inside the mall, a map of the floor where the user is present (e.g., FIG. 1A) may be pulled by or pushed to MS 100 from a server and displayed on a screen of MS 100. Alternatively, for example, maps may be preloaded on MS 100 prior to the user entering the mall. The user's location in the mall may be indicated by a silhouette figure on the map on MS 100's screen (e.g., FIG. 1A). The user in FIG. 1A is traveling in the direction of Elevator.

Locations of entities and structures inside the mall may be indicated by a coordinate system which may be a local coordinate system or a generalized global coordinate system, such as the WGS84 coordinate system used with GPS. For clarity, a local coordinate system is utilized in FIGS. 1A and 1B, and the coordinates are in the format (x, y, z) where x represents the position of an entity, a structure, etc. along the horizontal axis in FIGS. 1A and 1B, y represents the position of an entity or structure along the vertical axis in FIGS. 1A and 1B, and z represents the level of the shopping mall with 1 indicating level one (ground level) and 2 indicating level two. For example, the position of the user may be indicated by (18, 9, 1), Entrance/Exit 1 of the mall may be indicated by (18, 10, 1), the entrance/exit of SBARRO on mall level one may be indicated by (7, 9, 1), the entrance/exit points of Escalator 2 connecting levels one and two may be indicated by (8, 3, 1) on level one and (8, 3, 2) on level two, and the entrance/exit of PIZZA HUT on mall level two may be indicated by (18, 7, 2). Such entrances/exits and intersections of hallways, e.g., (7, 3, 1), may serve as vertices of a routing graph, and distances between such vertices may serve as edges of the routing graph, for example.

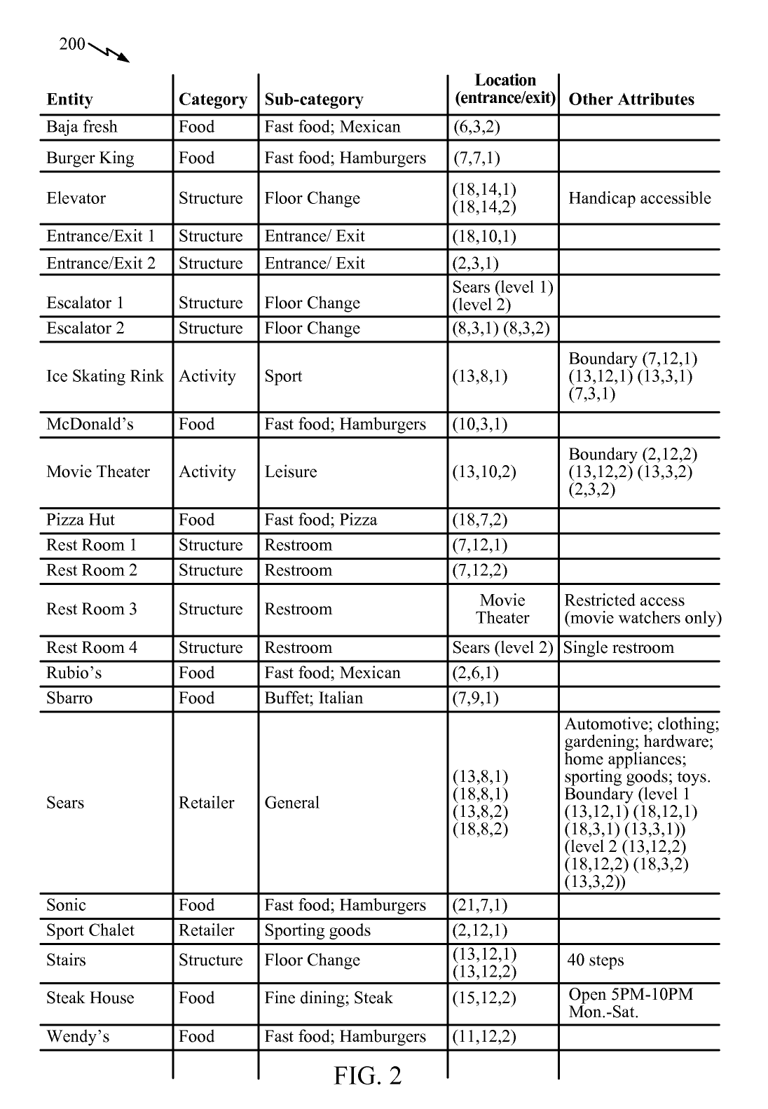

FIG. 2 illustrates database 200 which lists entities and structures in and near the shopping mall and information about the entities and structures. For example, such a database may be stored on a server controlled by the shopping mall. Database 200 may be transmitted to the user's MS 100 according to one design. The first column of database 200 indicates the name of an entity or structure. The second column of database 200 indicates the categories of the corresponding entities and structures in the first column. The third column indicates any sub-categories of the corresponding entities and structures. The fourth column indicates the locations of the entrances/exits of the corresponding entities and structures. The fifth column indicates any other attributes of the corresponding entities and structures.

For example, BAJA FRESH is in the “food” category and “fast food” and “Mexican” subcategories. Its entrance/exit is located at (6, 3, 2) (FIG. 2B). Elevator is in the “structure” category and “floor change” sub-category. Its entrances/exits are located at (18, 14, 1) on level one and (18, 14, 2) on level two. It is handicap/wheelchair accessible as indicated by the “Other Attributes” column. For the largest entities in the mall (Ice Skating Rink, Movie Theater, and SEARS), the “Other attributes” column contains coordinates that mark the boundaries of these entities. Rest Room 3 is located inside Movie Theater as indicated by the “Location” column, and it has restricted access and is available to movie watchers only as indicated by the “Other Attributes” column. Rest Room 4 is located in SEARS (level two of the mall) as indicated by the “Location” column and only includes a single rest room for one person at a time as indicated by the “Other Attributes” column. SEARS sells a variety of goods which are indicated by the “Other Attributes” column. Large entities such as Movie Theater or SEARS may have their own maps that may be transmitted to MS 100 when the user enters Movie Theater or SEARS. Steak House offers fine dining as indicated by the “Sub-category” column and has special business hours that are different from mall business hours, as indicated by the “Other Attributes” column. Database 200 may have more, less, or different information than what is shown in FIG. 2. For example, database 200 may have detailed information about menu choices/prices for restaurants and inventory items/prices for stores. As POI attributes change (e.g., a store moves out of the mall and another store moves in; a store prolongs its business hours during the holiday season, etc.), database 200 may be updated to reflect the new information. A current version of Database 200 or a link or pointer to database 200 may be transmitted to MS 100 (e.g., via Wi-Fi) whenever the user enters the mall. Database 200 may be a single database/data structure or a combination of databases/data structures.

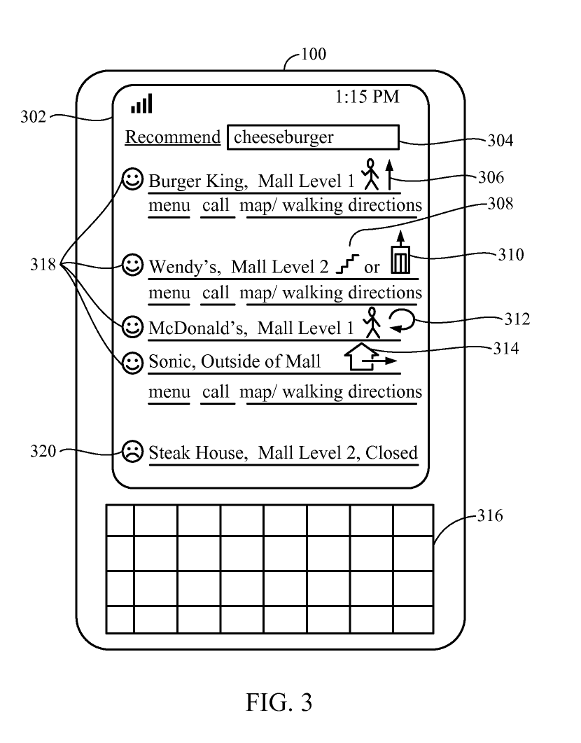

FIG. 3 illustrates a mobile station displaying location aware ordering of recommendations for the shopping mall. Display 302 of MS 100 shows a location aware recommendation application that receives user input in window 304 and provides a ranked list of location aware recommendations in response. In another design, the location aware recommendation interface may be integrated into a conventional search engine interface. The user may input a recommendation request in window 304 via keyboard 316, via an on-screen keyboard (not shown), via a speech-to-text feature of MS 100, and etc. After inputting the search request, the user may activate the recommendation process by typing the return key or clicking on the word “Recommend” on display 302, for example. In another design, an automated recommendation request may be received. For example, MS 100 or a server has determined that MS 100 is inside a mall as discussed and may access a calendar application and find out that it is the holiday season, and may automatically enter a recommendation request for “holiday gifts”.

In the example of FIG. 3, the current time is 1:15 pm as indicated on display 302 and the recommendation request “cheeseburger” has been entered. In response, the location aware recommendation engine provides a list of restaurants that may sell cheeseburgers within convenient walking distance of the user, ranked in the order of accessibility, e.g., from the most accessible to the least accessible, based on the user's current location, the locations associated with the restaurants, and/or accessibility criteria.

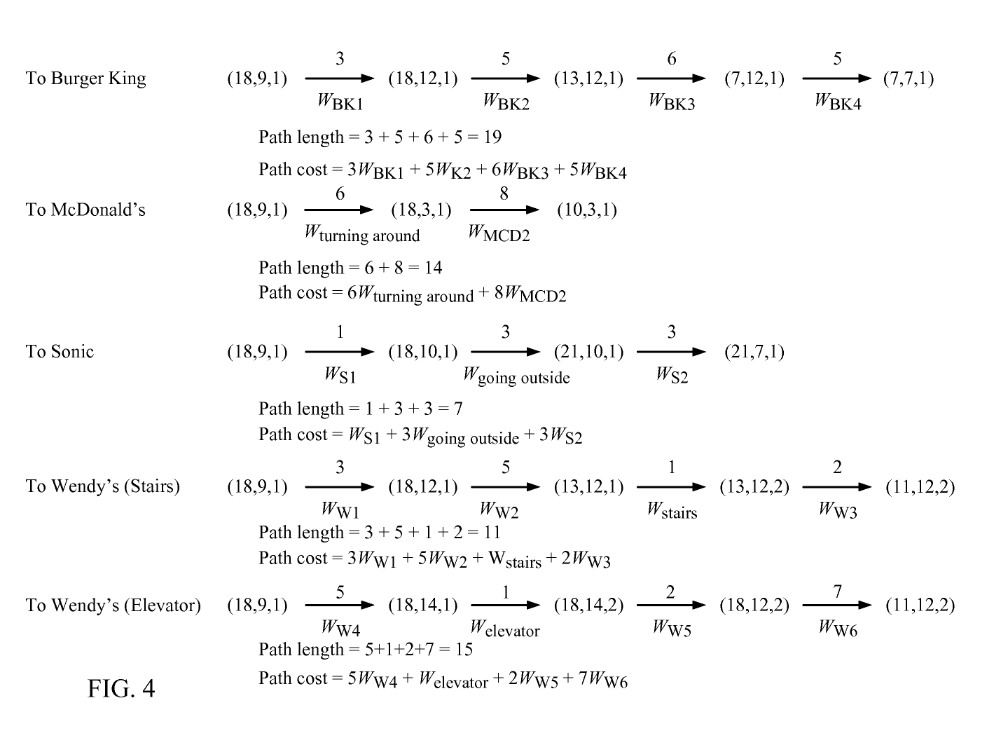

Accessibility criteria may include the length of the route to the destination, complexity of the route, the involvement of obstacles such as stairs, elevators, or escalators in the route to the destination, the need to turn around/reverse direction, congestion of the route, whether the destination is open for business or has restricted access, time or money required at the destination, whether the route involves leaving the current venue, etc. A methodology for generating the location aware ordering of recommendations of FIG. 3 will be discussed in detail below in connection with FIG. 4.

Staying with FIG. 3, the following is a description of the various icons on display 302. In this example, BURGER KING is ranked as the top recommendation for cheeseburger and icon 306, which has an arrow in the forward direction relative to the orientation of MS 100, indicates to the user that he/she should keep traveling forward from his/her current location en route to BURGER KING. WENDY'S, ranked second, is on level two of the mall, so icon 308 which indicates usage of stairs in the route to WENDY'S and icon 310 which indicates usage of elevator in the route to WENDY'S are displayed. Although the user can also reach level two via an escalator, no icon for escalator is displayed because the closest escalator to the user, Escalator 1, is inside SEARS and would involve the complexity of navigating through SEARS to get to it. Thus, stairs and the elevator are indicated as the most accessible options. McDONALD'S, ranked third, is on level one of the mall but the route involves reversing the current direction of the user, as indicated by icon 312. Current direction of the user may be detected, for example, via one or more sensors in MS 100 such as an accelerometer. For example, if a path based on walking directions to a destination suggested by MS 100 is within a +/−15 degree angle of the user's current direction, it may be assumed that the path is in the same direction as the user's current path. SONIC, ranked fourth, is outside of the mall, so icon 314 is displayed to indicate that it is outside the current venue. Icons 318 next to the first four restaurant recommendations indicate that they are reasonable choices. Steak House, ranked fifth, is closed at the current time based on information in database 200, therefore icon 320 indicates that it is an unreasonable choice. Although Steak House is currently closed, it is included in the list because it may present the user with another option for cheeseburgers in the future and the user may find out more information, such as hours of operation, about Steak House by clicking the Steak House link on display 302.

To find additional information about each of the reasonable choices, the user may click the corresponding restaurant name link on display 302. To look at the menu of one of these restaurants, to call one of these restaurants, or to invoke a map/walking directions to one of these restaurants, the user may click on the corresponding link on display 302. For example, after clicking the map/walking directions link for BURGER KING, a map such as FIG. 1A may be provided, e.g., on display 302 with the user's current location indicated by a silhouette figure. A route to BURGER KING may be determined by the location aware recommendation engine, e.g., based on the discussion below in connection with FIG. 4. Navigation guidance may be provided. For example, the route may be accentuated by a highly visible color such as yellow, by flashing the route on and off, by a series of flowing arrows placed along the route to BURGER KING, etc. As another example, navigation instructions, such as “keep walking straight”, “turn left at intersection”, “keep walking straight”, “turn left at Rest Room 1”, “keep walking straight”, and “turn right into BURGER KING”, may also be provided, e.g., visually via display 302 and/or audibly via a speaker device of MS 100. If the user does not make any selections after the recommendation screen on display 302 is provided, MS 100 may assume as a default that the highest ranked recommendation, BURGER KING in this case, is the destination. Thus, as the user travels in the mall, the arrow in icon 306 may change directions to point at the direction that the user should travel in to follow the route that reaches BURGER KING. However, if the user travels a significant distance from the location where the search request was entered without making a selection, the rankings of the recommendations may be dynamically reordered to reflect the changed location of mobile station 100 (and thus the changed location of the user) relative to locations of the recommended entities.

When the recommendation request for cheeseburger is received, a search may be invoked to determine one or more search results associated with the pedestrian environment. In this example, the location aware recommendation engine may determine that recommendations are to be made for restaurants that sell cheeseburgers and that are conveniently accessible by the pedestrian based on his/her current location. Since the current location of MS 100 (and thus the current location of the user) is determined to be in the mall, a search may be invoked to determine a relevant list of one or more entities in or near the mall that may sell cheeseburgers. This search may be performed using a relevancy search algorithm (e.g., one employed by a conventional search engine) that may utilize information in database 200 to determine which entities are relevant to selling cheeseburgers. The location aware recommendation engine may determine one or more search results associated with the mall (e.g., by invoking the relevancy search algorithm) and apply location aware criteria to the search results to produce a ranked results list as shown on display 302. The relevancy search algorithm may determine attributes of the search request. For example, attributes of the search request “cheeseburger” may be determined to be “fast food”, “hamburger”, etc. The relevancy search algorithm may match the determined attributes of the search request with attributes of one or more entities associated with the pedestrian environment (e.g., utilizing information in database 200) and insert each matched entity in a list of one or more search results. In this example, the relevancy search algorithm may return a list of matched entities including BURGER KING, McDONALD'S, SONIC, Steak House, and WENDY'S. The relevancy search algorithm may rank BURGER KING, McDONALD'S, SONIC, and WENDY'S as the most relevant since these entities are fast food hamburger restaurants and Steak House as partially relevant because it is a high end restaurant and selling hamburgers may not be its main business. Thus, the relevancy search may determine BURGER KING, McDONALD'S, SONIC, and WENDY'S to be of equal rank in terms of relevancy and insert them in alphabetical order by name before Steak House in the search results. If, for example, a recommendation request for “sushi” was entered instead of “cheeseburger”, the relevancy search may determine the attributes of the search request to be “sushi” and “Japanese food” and may determine that there are no entities in or near the mall that serve sushi or Japanese food. It may provide a search result indicating no matches found for sushi, and based upon this search result, the recommendation engine may provide the result “no sushi is available at this venue” for display on display 302. In this case, navigation guidance provided may be “no applicable map/directions.” If, for example, a recommendation request for “steak” was entered instead of “cheeseburger”, the relevancy search may determine that Steak House is the only relevant entity in or near the mall, and the recommendation engine may skip the total path cost determination (e.g., discussed in connection with FIG. 4) for Steak House and rank it as the top recommendation.

The application of location aware criteria to the list of search results from the relevancy search is now discussed in connection with FIG. 4, which illustrates a methodology for generating the location aware ordering of recommendations of FIG. 3. The methodology may determine a shortest path to an entity in the search results and apply a weight to a particular segment of the path or to the overall path, for example. The shortest path may be determined based on, e.g., a conventional shortest path algorithm with the current location of the user as the starting point and an entrance location of an entity as destination. For example, a version of Dijkstra's algorithm may be utilized. As discussed, the current location of the user may be determined, e.g., utilizing trilateration based on signal sources such as Wi-Fi access points or femtocells. Weight applied may be based on various accessibility criteria, which may include route travel time criteria, route complexity criteria, and/or availability criteria.

Route travel time criteria may include at least one of: a route distance between the location of the mobile station and the location associated with each search result; speed of travel; congestion on the route; time on stairs; time on an escalator; and/or time in an elevator.

Route complexity criteria may include at least one of: whether the route includes stairs; whether the route includes an escalator; whether the route includes an elevator; current travel direction; and/or whether the route includes leaving a current venue.

Availability criteria may include at least one of: whether an entity associated with the pedestrian environment is open or closed; whether the entity has access restrictions, time required at the entity, and/or money required at the entity. Each individual criterion may be assigned a weight value. Weight values may be combined with path length to determine a total path cost. Recommendations may be ranked based on each recommendation's total path cost. In some cases, one or more paths from the user's current direction to an entity may be determined to have a path length that is similar or close to the shortest path. In one design, a total path cost may be determined for each of these alternative paths and the path with the lowest total path cost will be utilized in the location aware ranking of the search results. In another design, a suitable number (e.g., two or three) of alternative paths with similar total path costs may be utilized in the location aware ranking of the search results.

For BURGER KING, database 200 indicates that its only entrance is at (7, 7, 1). A shortest path from the current user location, (18, 9, 1) in FIG. 1A, to (7, 7, 1) may be determined by applying a conventional shortest path algorithm with a starting point of (18, 9, 1) and an endpoint of (7, 7, 1) utilizing the local coordinate map of FIG. 1A. This path may be determined to be (18, 9, 1)->(18, 12, 1)->(13, 12, 1)->(7, 12, 1)->(7, 7, 1). The length of the path segment between (18, 9, 1) and (18, 12, 1) is 3 units, between (18, 12, 1) and (13, 12, 1) is 5 units, between (13, 12, 1) and (7, 12, 1) is 6 units, and between (7, 12, 1) and (7, 7, 1) is 5 units. Depending on the coordinate system used, a unit may be, for example, any suitable measurement of distance, e.g., a meter, 10 meters, a yard, 10 yards, a foot, 10 feet, etc. The length of the path may be determined to be the sum of the lengths of the segments, which is 19 in this example. Weight may be applied to each segment or to the overall path. In this example, the path from the user's current location to BURGER KING's entrance does not include, e.g., stairs, elevators, escalators, congestion, leaving the mall, access restrictions, etc., so a suitable base value (e.g., 1) for weight may be applied to each segment. For example, a segment that includes stairs or congestion may be assigned a suitable weight value higher than the base value (e.g., 20 for stairs and 15 for congestion). A segment that includes both stairs and congestion may be assigned a weight value that is the sum of the weight value for stairs and the weight value for congestion (e.g., 35). On the other hand, a segment that includes structures, etc. that aid pedestrian travel (e.g., motorized conveyor belts for passengers at an airport) may be assigned a weight value lower than the base value (e.g., 0 or −1). In this BURGER KING example, application of the weight to each segment includes multiplying the length of each segment by the weight value, but any suitable operation to apply the weight may be used. The resulting total path cost which includes the application of weight values may be: 3*W_{BK1}+5*W_{BK2}+6*W_{BK3}+5*W_{BK4}=3*1+5*1+6*1+5*1=19 (W_{BK1} denotes the weight value of segment 1 of the path to BURGER KING, and W_{BK2} denotes the weight value of segment 2 of the path to BURGER KING, etc.).

For McDONALD'S, the shortest path from the user's current location is determined to be (18, 9, 1)->(18, 3, 1)->(10, 3, 1) and this path length is determined to be 6+8=14 (FIG. 4). Although the path length to McDONALD'S is shorter than to BURGER KING, the segment from (18, 9, 1) to (18, 3, 1) involves turning around and traveling in the direction that is opposite to the direction that the user is currently traveling in. Pedestrian travel may feature a lot of sightseeing and window shopping. A reversal of direction may not be ideal in a pedestrian environment because it forces the user to go back over the same route that he/she has just traveled and to see the same sights and businesses that he/she has just seen. The weight value for reversal of direction may be assigned 10. Mobile station 100 may determine that the user has just traveled from (18, 3, 1) to (18, 9, 1), e.g., based on a feature that stores the path that mobile station 100 has traveled since entering the mall. Thus, the segment from (18, 9, 1) to (18, 3, 1) may be assigned a weight value of 10. The weight value of the segment from (18, 3, 1) to (10, 3, 1) may be assigned the base value of 1 (as discussed above in relation to BURGER KING). The resulting total path cost for McDONALD'S is therefore: 6*10+8*1=68. In another design, a suitable weight value may be added to the total path cost as a penalty for reversing direction instead of multiplying the segment length 6 by the weight value 10.

For SONIC, the shortest path from the user's current location is determined to be (18, 9, 1)->(18, 10, 1)->(21, 10, 1)->(21, 7, 1) and the path length is determined to be 1+3+3=7 (FIG. 4). Although the path length to SONIC is relatively short, the segment from (18, 10, 1) to (21, 10, 1) involves leaving the mall because SONIC is outside the mall. This exit from the user's current venue may not be ideal in a pedestrian environment because, e.g., it forces the user to leave a venue that the user may be familiar with and to face possibly different climate conditions outside. The weight value for leaving the current venue may be assigned 30. Thus, the segment from (18, 10, 1) to (21, 10, 1) may be assigned a weight of 30. The weight value of the other segments may be assigned the base value of 1 (as discussed above in relation to BURGER KING). The resulting total path cost is: 1*1+3*30+3*1=94.

For WENDY'S, the shortest path from the user's current location is determined to be (18, 9, 1)->(18, 12, 1)->(13, 12, 1)->(13, 12, 2)->(11, 12, 2) and the path length is determined to be 3+5+1+2=11 (FIG. 4). Although the path length to WENDY'S is relatively short, the segment from (13, 12, 1) to (13, 12, 2) involves Stairs since WENDY'S is on level two of the mall. Stairs may present an obstacle in a pedestrian environment because of the physical exertion involved, especially when the user is carrying shopping bags in the case of a shopping mall. The weight value assigned to stairs may be 20 and may vary, e.g., depending on the number of stair steps. Database 200 indicates that Stairs have 40 steps. Given such a high number of steps, a relatively higher weight value such as 30 may be assigned. Thus, the segment from (13, 12, 1) to (13, 12, 2) may be assigned a weight value of 30 (in the case of a user in a wheelchair, the weight value of stairs may be assigned a prohibitively high value, e.g., 100). The weight value of the other segments may be assigned the base value of 1 (as discussed above in relation to BURGER KING). The resulting total path cost is: 3*1+5*1+1*30+2*1=40.

For WENDY'S, there is an alternative path from the user's current location that is also relatively short. The path is determined to be (18, 9, 1)->(18, 14, 1)->(18, 14, 2)->(18, 12, 2)->(11, 12, 2) and the path length is determined to be 5+1+2+7=15 (FIG. 4). Although the alternative's path length to WENDY'S is relatively short, the segment from (18, 14, 1) to (18, 14, 2) involves Elevator. Elevators may present an obstacle in a pedestrian environment because, e.g., of the delays involved in waiting for the elevator. The weight value assigned to elevators may be 20. Thus, the segment from (18, 14, 1) to (18, 14, 2) may be assigned a weight of 20. However, in the case of a user in a wheelchair, an elevator may be the only practical way to change floors, so in this case the weight value of an elevator may be assigned a lower value (e.g., 10). The weight value of the other segments on this alternative path to WENDY'S may be assigned the base value of 1 (as discussed above in relation to BURGER KING). The resulting total path cost is: 5*1+1*20+2*1+7*1=34. Since the total path cost of this alternative path is lower than the path with the shortest path length, it may be provided as an option to the user. If the user selects map/walking directions for WENDY'S, an option for the path involving Stairs and an option for the path involving Elevator may be provided.

For Steak House, database 200 indicates its hours of operation are 5 pm-10 pm (Monday-Saturday) and given the current time of 1:15 pm, it is closed and will not be open for a long time. Thus, the location aware recommendation engine may skip the total path cost determination and simply assign, e.g., the highest possible total path cost to Steak House (e.g., infinity). In another design, the location aware recommendation engine may skip the total path cost determination for Steak House altogether and leave it off of the list of recommendations to be ranked. In another example, if the current day/time is Saturday 4:50 pm (10 minutes before Steak House opens), the location aware recommendation engine may proceed with the total path cost determination for Steak House and indicate on display 302 that Steak House will open at 5 pm.

The path lengths from the current user location to each entity returned by the relevancy search is: BURGER KING (18), McDONALD'S (14), SONIC (7), WENDY'S (11); Steak House (not applicable: restaurant closed). After taking into account accessibility criteria based on the methodology discussed in connection with FIG. 4, the total path cost for each result is: BURGER KING (18), McDONALD'S (68), SONIC (94), WENDY'S (40 for stairs; 34 for elevator); Steak House (infinity). Based on these total path costs, the location aware recommendation engine may rank the results in the order from lowest total path cost to highest total path cost (i.e., BURGER KING, WENDY'S, McDONALD'S, SONIC, Steak House) and provide this ranked list, e.g., to be displayed on display 302. Depending on design, functionality discussed in connection with FIG. 4 and other functionality discussed herein may be performed by MS 100, one or more servers (e.g., a server in direct or indirect communication with MS 100), or a combination of MS 100 and one or more servers.

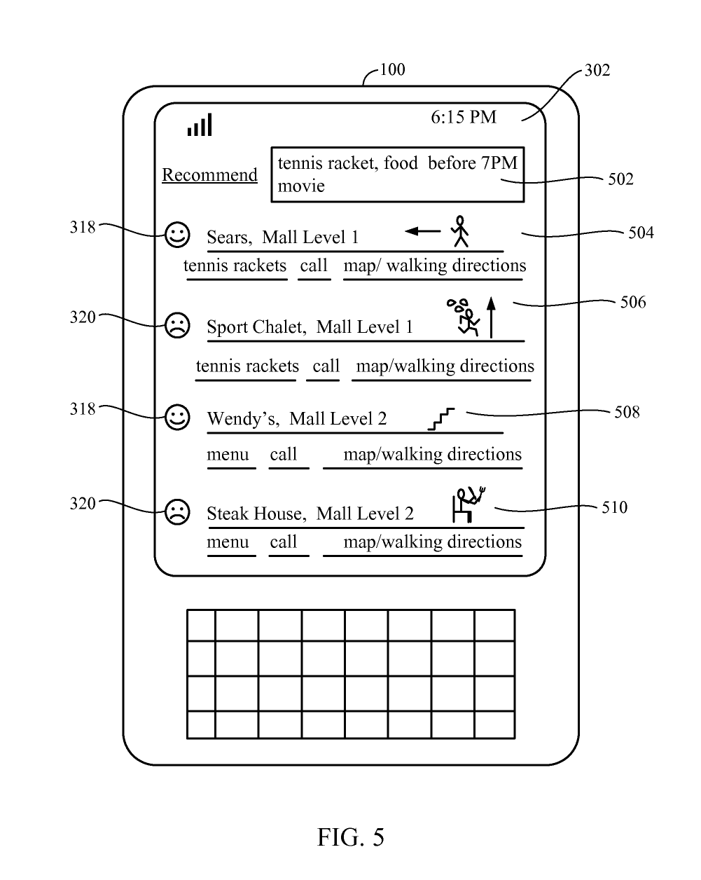

FIG. 5 illustrates a mobile station displaying another example of location aware ordering of recommendations. In this example, the current day/time is Saturday 6:15 pm and the user is at location (18, 9, 1) in the mall (FIG. 1A). The user needs to buy a tennis racket and have dinner before catching a 7 pm movie. He/she inputs the recommendation request “tennis racket, food before 7 PM movie” into window 502 of the location aware recommendation application. The recommendation engine may parse the input information, e.g., via a parsing algorithm utilized by a conventional search engine, and determine that the user has a time sensitive request for recommendations for a place to buy a tennis racket and for a place to get food. The recommendation engine may determine that the current time is 6:15 pm and the user only has at most 45 minutes to get a tennis racket and food. A relevancy search is made for “tennis racket” and the result includes SPORT CHALET and SEARS as entities where tennis rackets are sold. The relevancy search may be based on information in database 200 as discussed earlier. The relevancy search may determine that SPORT CHALET is more relevant than SEARS because SPORT CHALET specializes in sporting goods and may offer more tennis rackets and better purchasing advice.

Given the time constraint, however, the recommendation engine may determine that the shortest path length to SPORT CHALET from the current user location would take too much travel time, e.g., based on the user's average travel speed which may be determined by a pedometer feature of MS 100. The methodology discussed above in connection with FIG. 4 may take travel time into account, e.g., by adding a suitable value at the end of the total path cost determination for SPORT CHALET as an extra penalty, to emphasize the disadvantage of SPORT CHALET given the time sensitive nature of the request. The methodology may rank SEARS as the first recommendation to buy a tennis racket based on its close proximity to the user's current location and display it on display 302 with icon 504, which shows a left pointing arrow indicating to the user that he/she can turn left to reach SEARS. Icon 318 next to the SEARS recommendation indicates that it is a reasonable choice. Display 302 may display SPORT CHALET as the next recommendation to buy a tennis racket. Icon 320 next to the SPORT CHALET recommendation may indicate that it is not a reasonable choice and icon 506 may indicate the user has to rush if he/she wants to go to SPORT CHALET. The “tennis rackets” link under both the SEARS and SPORT CHALET recommendations may indicate that more information about tennis rackets at the respective stores may be accessed by selecting the link. Information on tennis rackets and other items available at entities in the mall may include, if applicable, brands, models, pictures, prices, etc. and may be stored in database 200. Without the time constraint in this example, the location aware recommendation engine may rank SPORT CHALET higher than SEARS, e.g., because of its higher relevancy. In another example, a recommendation request may be associated with a monetary constraint, such as a recommendation request for “food for $5”. In this case, the recommendation engine may determine that restaurants in the fast food sub-category of database 200 are relevant. For restaurants not in the fast food sub-category, the recommendation engine may determine the money required at these restaurants based on menu/price information, e.g., in database 200. If one of these restaurants has a reasonable number of choices on the menu that are, e.g., $5 or less, the recommendation engine may determine the restaurant to be relevant to the recommendation request. The recommendation engine may rank the relevant restaurants, e.g., based on the methodology discussed in connection with FIG. 4, and provide the ranked results to be displayed on MS 100. The recommendation engine may handle other recommendation requests or combinations of recommendation requests (e.g., “tennis racket under $50, food for $5 before 7 pm movie”, etc.) and the claimed subject matter is not limited in this respect.

Continuing with the example of FIG. 5, a relevancy search for food may return many entities which are of equal relevancy because they all sell food at the mall. Given that the user has another destination (Movie Theater) after getting food, the recommendation engine may apply the total path cost methodology discussed in connection with FIG. 4 in a different way. Here, instead of applying the methodology utilizing the user's location as the origin and a restaurant's location as the destination, it may apply the methodology utilizing a restaurant's location as the origin and Movie Theater's location as the destination, e.g., because guiding the user to a restaurant that has the lowest total path cost to the user's final destination, Movie Theater, will be the most efficient use of time. Without the 7 pm time constraint, this particular application of the methodology may determine that Steak House is now open and that WENDY'S and Steak House have the lowest total path cost to Movie Theater. In response to the time constraint, the methodology may additionally determine that Steak House is a fine dining restaurant and it may take too long to get food there. The methodology may apply a suitable weight value to the total path cost of Steak House as a penalty to reflect the longer time to get food. For example, the weight value may be applied as part of the availability criterion because the longer time required at Steak House by customers makes Steak House less available than WENDY'S. Thus, the recommendation engine may recommend WENDY'S as the first choice for getting food before the movie. Icon 508 may indicate that reaching WENDY'S from the user's current location involves the use of Stairs. Icon 318 on display 302 may indicate that WENDY'S is a reasonable choice. Icon 320 on display 302 may indicate that Steak House is not a reasonable choice. Icon 510 may indicate that Steak House is a fine dining restaurant and therefore time-consuming.

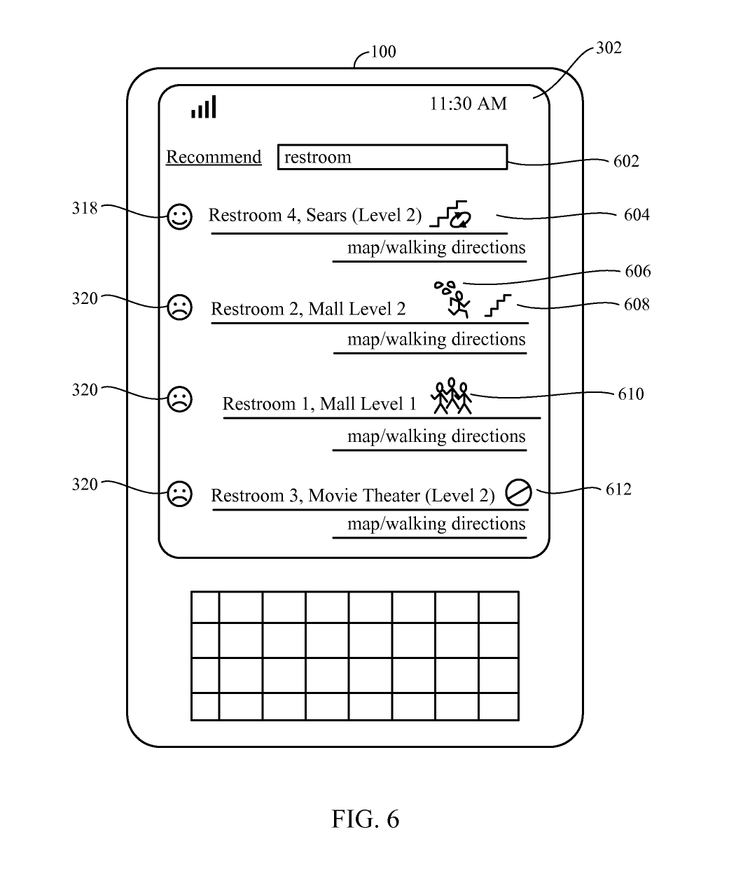

FIG. 6 illustrates a mobile station displaying another example of location aware ordering of recommendations. In this example, the user is at location (18, 9, 1) in the mall (FIG. 1A) and needs to use the restroom. The user looks around and does not see a restroom in the vicinity, so he/she inputs “restroom” in window 602 of the location aware recommendation application. The recommendation engine may parse the input information, determine that the user is looking for the nearest restroom, and implicitly interpret this request as time sensitive. The relevancy search results may include the four rest rooms inside the mall, all with equal relevance. The recommendation engine may apply the total path cost methodology discussed in connection with FIG. 4 to the list of relevancy search results.

The shortest path to Rest Room 1 may be determined to be (18, 9, 1)->(18, 12, 1)->(7, 12, 1) with a path length of 3+11=14. In this example, there is a crowd of people near the entrance to Rest Room 1 (7, 12, 1) and MS 100 may determine that there is congestion near the entrance to Rest Room 1, as indicated by a number of mobile stations (and thus the number of people) that have estimated positions near (7, 12, 1). MS 100 may receive this information from a server via the wireless access point that it is in communication with. The location aware recommendation engine may therefore determine that there is a waiting line for Rest Room 1 and add a suitable weight value for the congestion to the total path cost determination for Rest Room 1. Other than this congestion at Rest Room 1, there is no additional accessibility criterion for which a weight value may be applied to the total path cost for Rest Room 1. For example, a suitable weight value (e.g., 50) may be added as a penalty for the congestion, and the total path cost for Rest Room 1 may be determined to be 3*1+11*1+50=64. In a different example, a recommendation request for Mexican food may be entered when the user is at (18, 9, 1). A relevancy search may determine RUBIO'S and BAJA FRESH as being equally relevant to Mexican food. It may be the holiday season and there may be a large crowd gathered around Ice Skating Rink to watch an ice skating performance. The location aware recommendation engine may determine that the congestion around Ice Skating Rink would interfere with paths leading to RUBIO'S and apply a suitable weight value as penalty for the congestion. BAJA FRESH may be determined as the top recommendation in this case even though it is on the second level and involves a floor change to reach it.

Back to the rest room example of FIG. 6, the shortest path to Rest Room 2 may be determined to be a path that includes Stairs: (18, 9, 1)->(18, 12, 1)->(13, 12, 1)->(13, 12, 2)->(7, 12, 2) with a path length of 3+5+1+6=15. As discussed above in connection with FIG. 4, the weight value for Stairs may be 30. Thus, the total path cost for this path may be 3*1+5*1+1*30+6*1=44. If taking a path that includes Elevator, the path may be determined to be (18, 9, 1)->(18, 14, 1)->(18, 14, 2)->(18, 12, 2)->(7, 12, 2) with a path length of 5+1+2+11=19. As discussed in connection with FIG. 4, the weight value for Elevator may be 20. Thus, the total path cost for this path may be 5*1+1*20+2*1+11*1=38. However, a path involving an elevator may involve unpredictable wait times for the elevator, and given the time sensitive nature of this recommendation request, the recommendation engine may not present the path to Rest Room 2 involving Elevator because there exists another path to Rest Room 2 (via Stairs) with only a somewhat higher total path cost but a more predictable travel time.

For Rest Room 3, database 200 indicates that it is located in Movie Theater and only movie watchers have access. Thus, the location aware recommendation engine may skip the total path cost determination for Rest Room 3 and simply assign, for example, the highest possible path cost to Rest Room 3 (e.g., infinity). In another example, if the location aware recommendation engine determines that the user has a next destination and that it is Movie Theater (e.g., the user is going to watch a movie), it may proceed with the total path cost determination for Rest Room 3. In yet another example, database 200 may indicate the times for which a rest room is closed for cleaning. If the recommendation engine determines that a rest room is currently closed for cleaning, it may skip the total path cost determination for the rest room and simply assign, for example, the highest possible path cost to the rest room (e.g., infinity) and display a suitable icon on display 302 to indicate that it is closed. Similarly, database 200 may indicate that one of the entities (e.g., Elevator or Escalator 2) is out of service and the recommendation engine may avoid paths that utilize the out-of-service entity.

The shortest path to Rest Room 4 may be determined to be a path that includes going into SEARS as well as utilizing Escalator 1 inside SEARS. In this example, SEARS has its own server which can display a map of the inside of the store with local coordinates. Thus, database 200 only has information that Rest Room 4 is in SEARS on the second level of the mall and that it is a single rest room, without coordinates of the entrance to Rest Room 4. Here, the location aware recommendation engine may estimate the path length to Rest Room 4 based on the boundary of SEARS as indicated by database 200. Based on database 200, the first level of SEARS is bounded by a rectangle with the coordinates (13, 12, 1), (18, 12, 1), (18, 3, 1) and (13, 3, 1) and the second level of SEARS is bounded by a rectangle with the coordinates (13, 12, 2), (18, 12, 2), (18, 3, 2), and (13, 3, 2). Based on these boundary coordinates, SEARS may be estimated to be 9 units long and 5 units wide. Thus, a worst case scenario in traveling inside of SEARS is getting from one corner of SEARS to a diagonal corner, and a worst case path length may be 9+5=14 (travel along the entire length of SEARS and then along the entire width). The shortest path in this example may be determined to be (18, 9, 1)->(18, 8, 1)->[(SEARS level one)->(Escalator 1)->(SEARS Level two)]=1+[travel inside SEARS]. In this example, the shortest path may lead the user to enter SEARS via the entrance at (18, 8, 1), which is about the mid-point along the length of SEARS. Thus, the worst case travel distance for the user to any point inside SEARS may be estimated to be ½*(length of SEARS)+(width of SEARS)=½*9+5≈11. Traveling from the user's current location on level one to Rest Room 4 in the second level of SEARS involves Escalator 1 and the weight value associated with Escalator 1. In this example, Escalator 1 may be assigned a weight value of 10 as a penalty for the floor change involved. The weight value of an escalator may be lower than the weight value of stairs and elevators because it does not involve physical exertion such as climbing stairs or waiting such as for an elevator. In addition, a suitable weight value (e.g., 10) may be added as a penalty for the complexity of navigating through the inside of a big entity like SEARS. Thus, an estimated total path cost for Rest Room 4 may be determined to be 11+10+10=31. As the user enters SEARS, a map of SEARS may be displayed on display 302 to provide turn by turn directions to Rest Room 4.

Based on the total path costs for Rest Room 1 (64), Rest Room 2 (44), Rest Room 3 (infinity), and Rest Room 4 (31), the location aware recommendation engine may rank the rest rooms in the order from lowest total path cost to highest total path cost: Rest Room 4, Rest Room 2, Rest Room 1, and Rest Room 3, with Rest Room 4 being the most highly recommended. This location aware ranked list of search results may be provided to display 302. Icon 604 of display 302 may indicate that the path to Rest Room 4 includes an escalator. Icon 318 may indicate that Rest Room 4 is a reasonable choice. Icon 608 may indicate that the path to Rest Room 2 includes stairs. Icon 606 may indicate that the user may need to rush to reach Rest Room 2 given the time sensitive nature of the recommendation request. Icon 320 may indicate that Rest Room 2 is not a reasonable choice. Icon 610 may indicate that there is congestion at Rest Room 1 or on the path to Rest Room 1. Icon 320 may indicate that Rest Room 1 is not a reasonable choice. Icon 612 may indicate that Rest Room 3 has restricted access. Icon 320 may indicate that Rest Room 3 is not a reasonable choice.

In some designs, the location aware recommendation engine may be configurable, e.g., via a configuration menu in the user application, via automated configuration by MS 100 or a server, etc. For example, a user in a wheelchair may indicate that he/she is in a wheelchair. In response, the recommendation engine may rank entities that are on the same level/floor as the user higher than entities that may require a level/floor change. A user may also customize the weight values assigned to various accessibility criteria. For example, the user may not mind reversing direction to reach a recommended entity so he/she may lower the default weight value associated with reversing current direction to a suitable value. The total path cost associated with each recommendation may be configured to be displayed on display 302 to give the user information about how close one recommendation is to, e.g., the next recommendation on the list in terms of total path cost, which may allow the user to make a more informed decision about which recommendation to pursue. Emphasis on the relevancy or on the location awareness of the recommendation results may be adjusted. For example, the default setting may indicate that all recommendations should be ranked according to total path cost, e.g., determined based on the methodology discussed in connection with FIG. 4. The user may reconfigure the setting such that all recommendations should be ranked according to relevancy to the recommendation request as determined by the relevancy search, with the most relevant result listed as the top recommendation (unless, e.g., an entity is not accessible: due to it being closed, having restricted access, or due to the time sensitivity of a request), and equally relevant results may be ranked based on total path cost. As another example, the user may configure a maximum travel distance for which he/she is willing to travel to reach a recommended entity, and any entity that has a total path length from the user's current position that is longer than the maximum travel distance may not be included as a recommendation. Similarly, the user may configure a maximum total path cost that he/she is willing to incur in order to reach an entity. In one design, the location aware recommendation engine may perform a location aware search upon receiving a recommendation request to determine one or more entities that are, e.g., within a suitable or user-configured total path length/total path cost based on the user's current position, and rank the one or more entities based on their relevancy to the recommendation request.

In some designs, the location aware recommendation engine may automatically adjust its settings. For example, it may determine from user history that the user has selected WENDY'S more often than BURGER KING, McDONALD's, or SONIC and may determine WENDY'S to be the user's favorite hamburger restaurant in the mall. Next time WENDY'S is among the relevancy search results, the recommendation engine may increase its rank, e.g., by decreasing its total path cost, to improve the chances that WENDY'S is among the reasonable alternatives. As another example, the recommendation engine may determine from user history that MS 100's location was often found to be within the boundary coordinates of SEARS whenever the user visits the mall. The recommendation engine may determine that SEARS is one of the user's favorite stores and may make suitable adjustments to paths leading to recommended entities so that the paths take the user near one of the SEARS entrances, e.g., to provide the user an opportunity to stop by SEARS and browse inside.

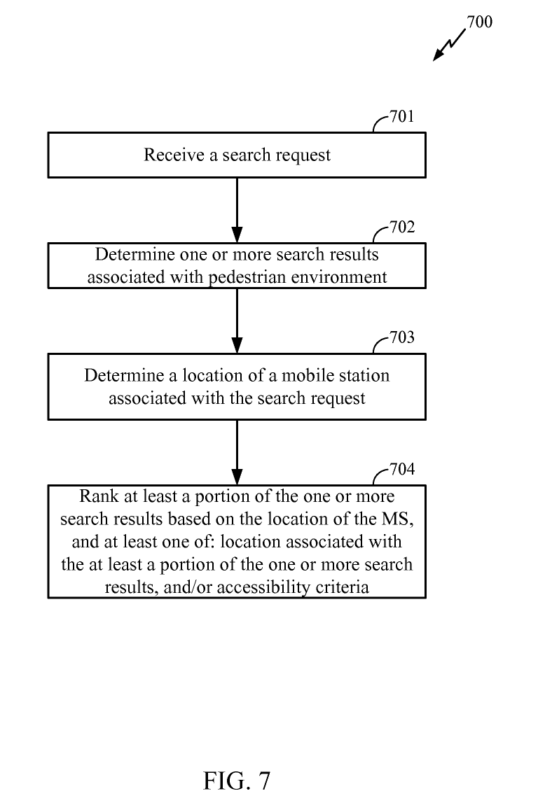

FIG. 7 is an illustrative diagram for generating location aware ordering of recommendations for a pedestrian environment. At block 701, a search request may be received. At block 702, one or more search results associated with the pedestrian environment may be determined. At block 703, the location of a mobile station associated with the search request may be determined. For example, the mobile station associated with the search request may be the mobile station on which a user enters a recommendation request or for which an automated recommendation request is entered, etc. For example, block 703 may be performed before block 702 or simultaneously with block 702. At block 704, at least a portion of the one or more search results may be ranked based on the location of the MS, and at least one of: location associated with the one or more search results, and/or accessibility criteria.

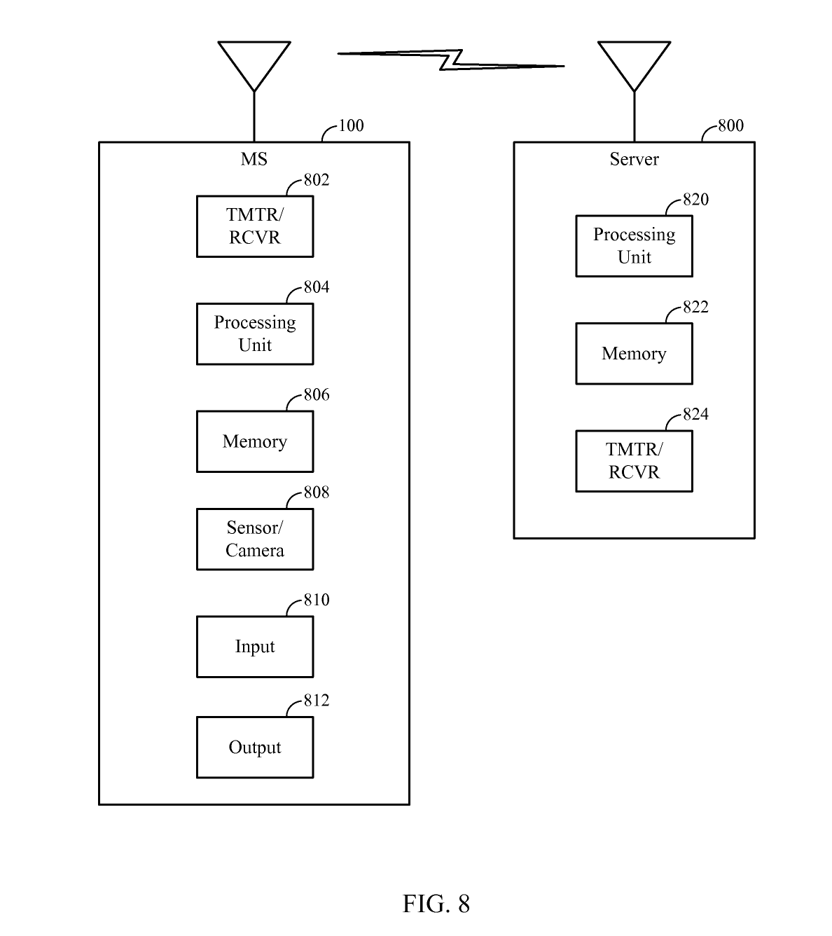

FIG. 8 illustrates a block diagram of a system for communicating with a mobile station that may be utilized in connection with a location aware recommendation engine. MS 100 may include transmitter/receiver (TMTR/RCVR) 802, processing unit 804, memory 806, sensors/camera 808, input 810, and output 812. Server 800 may include processing unit 820, memory 822, and transmitter/receiver (TMTR/RCVR) 824. Server 800 may be managed by a pedestrian venue such the mall of FIGS. 1A and 1B. MS 100 and Server 800 may communicate via a wireless network, e.g., a wireless local area network such as a Wi-Fi network.

MS 100 may transmit, e.g., signaling, data, and messages to other devices and receive, e.g., signaling, data, and messages from other devices via transmitter/receiver 802. Transmitter/receiver 802 may include a Wi-Fi transceiver, a cellular transceiver, a GPS receiver, a Bluetooth transceiver, a USB transceiver, etc. Memory 806 may store information and code in connection with the location aware recommendation engine, such as maps of a venue (e.g., FIGS. 1A and 1B), database 200, the location aware recommendation application, user history, etc. Depending on the design, processing unit 804 may perform or direct the performance of various functionalities illustrated in FIG. 7 and other functionalities discussed herein under the direction of code stored in memory 806, for example. Sensor/Camera 808 may include an accelerometer, a gyroscope, an altimeter, a temperature sensor, an ambient light sensor, a digital camera (e.g., capable of high definition images and video), etc. Input 808 may include a microphone system (e.g., a noise canceling microphone system), a keypad/keyboard (e.g., keypad/keyboard 316), a display screen with touch/sense capabilities (e.g., display 302), knobs/wheels, an HDMI receiver, etc. Output 810 may include a speaker, a display screen (e.g., display 302), a projector, a shake/vibration generator, an HDMI transmitter, etc. MS 100 may determine its current location as discussed and transmit its current location to server 800.

Server 800 may transmit, e.g., signaling, data, and messages to other devices and receive, e.g., signaling, data, and messages from other devices via transmitter/receiver 824. Transmitter/receiver 824 may include a Wi-Fi transceiver, an Ethernet connection, a Bluetooth transceiver, a USB transceiver, etc. Memory 822 may store information and code in connection with the location aware recommendation engine, such as maps of a venue (e.g., FIGS. 1A and 1B), database 200, and locations of Wi-Fi access points/femtocells in the venue. Depending on the design, processing unit 820 may perform or direct the performance of various functionalities illustrated in FIG. 7 and other functionalities discussed herein under the direction of code stored in memory 822, for example.

As used herein, a mobile station (MS) refers to a device such as a cellular or other wireless communication device, personal communication system (PCS) device, personal navigation device (PND), Personal Information Manager (PIM), Personal Digital Assistant (PDA), laptop, tablet, netbook, smartbook, or other suitable mobile device which is capable of receiving wireless communication and/or navigation signals. The term “mobile station” is also intended to include devices which communicate with a personal navigation device (PND), such as by short-range wireless, infrared, wireline connection, or other connection—regardless of whether satellite signal reception, assistance data reception, and/or position-related processing occurs at the device or at the PND. Also, “mobile station” is intended to include all devices, including wireless communication devices, computers, laptops, etc. which are capable of communication with a server, such as via the Internet, Wi-Fi, or other network, and regardless of whether satellite signal reception, assistance data reception, and/or position-related processing occurs at the device, at a server, or at another device associated with the network. Any operable combination of the above are also considered a “mobile station.”

The methodologies discussed herein may be implemented by various means depending upon the application. For example, these methodologies may be implemented in hardware, firmware, software, or any combination thereof. For an implementation involving hardware, the processing units may be implemented within one or more application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, electronic devices, other electronic units designed to perform the functions discussed herein, or a combination thereof.

For an implementation involving firmware and/or software, the methodologies may be implemented with modules (e.g., procedures, functions, and so on) that perform the functions discussed herein. Any machine-readable medium tangibly embodying instructions may be used in implementing the methodologies discussed herein. For example, software codes may be stored in a memory and executed by a processing unit. Memory may be implemented within the processing unit or external to the processing unit. As used herein the term “memory” refers to any type of long term, short term, volatile, nonvolatile, or other memory and is not to be limited to any particular type of memory or number of memories, or type of media upon which memory is stored.

For an implementation involving firmware and/or software, the functions may be stored as one or more instructions or code on a computer-readable medium. Examples include computer-readable media encoded with a data structure and computer-readable media encoded with a computer program. Computer-readable medium may take the form of an article of manufacture. Computer-readable medium includes physical computer storage media. A storage medium may be any available medium that can be accessed by a computer. By way of example, and not limitation, such computer-readable media can comprise RAM, ROM, EEPROM, CD-ROM or other optical disk storage, magnetic disk storage, semiconductor storage, or other storage devices, or any other medium that can be used to store desired program code in the form of instructions or data structures and that can be accessed by a computer; disk and disc, as used herein, includes compact disc (CD), laser disc, optical disc, digital versatile disc (DVD), floppy disk and Blu-ray disc where disks usually reproduce data magnetically, while discs reproduce data optically with lasers. Combinations of the above should also be included within the scope of computer-readable media.

In addition to storage on computer-readable medium, instructions and/or data may be provided as signals on transmission media included in a communication apparatus. For example, a communication apparatus may include a transceiver having signals indicative of instructions and data. The instructions and data are configured to cause one or more processing units to implement the functions outlined in the claims. That is, the communication apparatus includes transmission media with signals indicative of information to perform disclosed functions. At a first time, the transmission media included in the communication apparatus may include a first portion of the information to perform the disclosed functions, while at a second time the transmission media included in the communication apparatus may include a second portion of the information to perform the disclosed functions.

Some portions of the detailed description are presented in terms of algorithms or symbolic representations of operations on binary digital signals stored within a memory of a specific apparatus or special purpose computing device or platform. In the context of this specification, the term specific apparatus, special purpose apparatus, or the like includes a general purpose computer once it is programmed to perform particular functions pursuant to instructions from program software. Algorithmic descriptions or symbolic representations are examples of techniques used by those of ordinary skill in the signal processing or related arts to convey the substance of their work to others skilled in the art. An algorithm as here, and generally, is considered to be a self-consistent sequence of operations or similar signal processing leading to a desired result. In this context, operations or processing involve physical manipulation of physical quantities. Typically, although not necessarily, such quantities may take the form of electrical or magnetic signals capable of being stored, transferred, combined, compared or otherwise manipulated.

It has proven convenient at times, principally for reasons of common usage, to refer to such signals as bits, data, values, elements, symbols, characters, terms, numbers, numerals or the like. It should be understood, however, that all of these or similar terms are to be associated with appropriate physical quantities and are merely convenient labels. Unless specifically stated otherwise, it is appreciated that throughout this specification discussions utilizing terms such as “processing,” “computing,” “calculating,” “determining” or the like refer to actions or processes of a specific apparatus, such as a special purpose computer or a similar special purpose electronic computing device. In the context of this specification, therefore, a special purpose computer or a similar special purpose electronic computing device is capable of manipulating or transforming signals, typically represented as physical electronic or magnetic quantities within memories, registers, or other information storage devices, transmission devices, or display devices of the special purpose computer or similar special purpose electronic computing device. For example, a specific computing apparatus, a special purpose apparatus, or the like may include a processing unit programmed with instructions to perform one or more specific functions.

“Instructions” as referred to herein relate to expressions which represent one or more logical operations. For example, instructions may be “machine-readable” by being interpretable by a machine for executing one or more operations on one or more data objects. However, this is merely an example of instructions and claimed subject matter is not limited in this respect. In another example, instructions as referred to herein may relate to encoded commands which are executable by a processing unit having a command set which includes the encoded commands. Such an instruction may be encoded in the form of a machine language understood by the processing unit. Again, these are merely examples of an instruction and claimed subject matter is not limited in this respect.

The functions, steps and/or actions of the claims in accordance with embodiments of the invention discussed herein need not be performed in any particular order unless stated otherwise. Furthermore, although elements of the invention may be discussed or claimed in the singular, the plural is contemplated unless limitation to the singular is explicitly stated. While there has been illustrated and discussed what are presently considered to be example features, it will be understood by those skilled in the art that various other modifications may be made, and equivalents may be substituted, without departing from claimed subject matter. Additionally, many modifications may be made to adapt a particular situation to the teachings of claimed subject matter without departing from the central concept discussed herein. Therefore, it is intended that claimed subject matter not be limited to the particular examples disclosed, but that such claimed subject matter may also include all aspects falling within the scope of appended claims, and equivalents thereof.

What is claimed is:

1. A method for ranking recommendations for a pedestrian environment, comprising:
receiving a search request; and
in response to the search request:
determining one or more search results associated with the pedestrian environment;
determining a location of a mobile station associated with the search request;
ranking at least a portion of the one or more search results based at least in part on the location of the mobile station and at least one of: location associated with the at least a portion of the one or more search results, and/or accessibility criteria.

2. The method of claim 1, wherein the search request comprises at least one of: user input and/or an automated search request.

3. The method of claim 1, further comprising providing navigation guidance to at least one of the one or more search results.

4. The method of claim 1, wherein determining the one or more search results comprises:
determining attributes of the search request;
matching the attributes of the search request with attributes of one or more entities associated with the pedestrian environment; and
inserting each matched entity in the one or more search results.

5. The method of claim 1, wherein the accessibility criteria comprise at least one of route travel time criteria, route complexity criteria, and/or availability criteria.

6. The method of claim 1, wherein each accessibility criterion is assigned a weight.

7. The method of claim 5, wherein the route travel time criteria comprise at least one of:
a route distance between the location of the mobile station and the location associated with each of the at least a portion of the one or more search results;
speed of travel;
congestion on the route;
time on stairs;
time on an escalator; and/or
time in an elevator.

8. The method of claim 5, wherein the route complexity criteria comprise at least one of:
whether a route includes an escalator;
whether the route includes stairs;
whether the route includes an elevator;
current travel direction; and/or
whether the route includes leaving a current venue.

9. The method of claim 5, wherein the availability criteria comprise at least one of:
whether an entity associated with the pedestrian environment is open or closed;
whether the entity has access restrictions;
money required at the entity; and/or
time required at the entity.

10. The method of claim 1, further comprising dynamically reordering the ranked portion of the one or more search results as the mobile station changes position in the pedestrian environment.

11. An apparatus for ranking recommendations for a pedestrian environment, comprising:
a processing unit configured to:
receive a search request; and
in response to the search request:
determine one or more search results associated with the pedestrian environment;
determine a location of a mobile station associated with the search request;
rank at least a portion of the one or more search results based at least in part on the location of the mobile station and at least one of: location associated with the at least a portion of the one or more search results, and/or accessibility criteria.

12. The apparatus of claim 11, wherein the search request comprises at least one of: user input and/or an automated search request.

13. The apparatus of claim 11, wherein the processing unit is further configured to provide navigation guidance to at least one of the one or more search results.

14. The apparatus of claim 11, wherein the processing unit is further configured to:
determine attributes of the search request;
match the attributes of the search request with attributes of one or more entities associated with the pedestrian environment; and
insert each matched entity in the one or more search results.

15. The apparatus of claim 11, wherein the accessibility criteria comprise at least one of route travel time criteria, route complexity criteria, and/or availability criteria.

16. The apparatus of claim 11, wherein each accessibility criterion is assigned a weight.

17. The apparatus of claim 15, wherein the route travel time criteria comprise at least one of:
a route distance between the location of the mobile station and the location associated with each of the at least a portion of the one or more search results;
speed of travel;
congestion on the route;
time on stairs;
time on an escalator; and/or
time in an elevator.

18. The apparatus of claim 15, wherein the route complexity criteria comprise at least one of:
whether a route includes an escalator;
whether the route includes stairs;
whether the route includes an elevator;
current travel direction; and/or
whether the route includes leaving a current venue.

19. The apparatus of claim 15, wherein the availability criteria comprise at least one of:
whether an entity associated with the pedestrian environment is open or closed;
whether the entity has access restrictions;
money required at the entity; and/or
time required at the entity.

20. The apparatus of claim 11, wherein the processing unit is further configured to dynamically reorder the ranked portion of the one or more search results as the mobile station changes position in the pedestrian environment.

21. An apparatus for ranking recommendations for a pedestrian environment, comprising:
means for receiving a search request;
means for determining one or more search results associated with the pedestrian environment in response to the search request;
means for determining a location of a mobile station associated with the search request; and
means for ranking at least a portion of the one or more search results based at least in part on the location of the mobile station and at least one of:
location associated with the at least a portion of the one or more search results, and/or accessibility criteria.

22. The apparatus of claim 21, wherein the search request comprises at least one of: user input and/or an automated search request.

23. The apparatus of claim 21, further comprising means for providing navigation guidance to at least one of the one or more search results.

24. The apparatus of claim 21, wherein the means for determining the one or more search results comprises:
means for determining attributes of the search request;
means for matching the attributes of the search request with attributes of one or more entities associated with the pedestrian environment; and
means for inserting each matched entity in the one or more search results.

25. The apparatus of claim 21, wherein the accessibility criteria comprise at least one of route travel time criteria, route complexity criteria, and/or availability criteria.

26. The apparatus of claim 21, wherein each accessibility criterion is assigned a weight.

27. The apparatus of claim 25, wherein the route travel time criteria comprise at least one of:
a route distance between the location of the mobile station and the location associated with each of the at least a portion of the one or more search results;
speed of travel;
congestion on the route;
time on stairs;
time on an escalator; and/or
time in an elevator.

28. The apparatus of claim 25, wherein the route complexity criteria comprise at least one of:
whether a route includes an escalator;
whether the route includes stairs;
whether the route includes an elevator;
current travel direction; and/or
whether the route includes leaving a current venue.

29. The apparatus of claim 25, wherein the availability criteria comprise at least one of:
whether an entity associated with the pedestrian environment is open or closed;
whether the entity has access restrictions;
money required at the entity; and/or
time required at the entity.

30. The apparatus of claim 21, further comprising means for dynamically reordering the ranked portion of the one or more search results as the mobile station changes position in the pedestrian environment.

31. A computer readable medium comprising instructions stored thereon which are adapted to direct a processing unit to perform ranking of recommendations for a pedestrian environment, the instructions comprising:
code to receive a search request; and
code to:
in response to the search request:
determine one or more search results associated with the pedestrian environment;
determine a location of a mobile station associated with the search request;
rank at least a portion of the one or more search results based at least in part on the location of the mobile station and at least one of: location associated with the at least a portion of the one or more search results, and/or accessibility criteria.
